(19) United States
(12) Patent Application Publication
(10) Pub. No.: US 2026/0229391 A1
(43) Pub. Date: Aug. 6, 2026

(54) SEALING ARRANGEMENT AND USE THEREOF

(71) Applicant: Carl Freudenberg KG, Weinheim (DE)

(72) Inventors: Carsten FORMER, Gorxheimertal (DE); Ralf HELDMANN, Wald-Michelbach (DE); Markus CLEMENS, Reichelsheim (DE); Rouven RATFISCH, Gernsheim (DE)

(21) Appl. No.: 19/155,964

(22) PCT Filed: Feb. 7, 2024
(86) PCT No.: PCT/EP2024/053028

§ 371 Date: Aug. 13, 2025

(30) Foreign Application Priority Data
Feb. 16, 2023 (DE) 10 2023 103 874.5

(51) Int. Cl. H01B 17/30

(52) U.S. Cl. CPC H01B 17/303

(57) ABSTRACT

A sealing arrangement includes a busbar with at least one electrical conductor, and a two-component part. The two-component part includes a supporting part made of a semi-rigid material, and a sealing body made of a rubber-elastic sealing material, which is integrally bonded to the supporting part. The sealing body sealingly surrounds the electrical conductor without adhering to it.

### CROSS REFERENCE TO RELATED APPLICATIONS

This application is a U.S. National Phase application under 35 U.S.C. § 371 of International Application No. PCT/EP2024/053028, filed on Feb. 7, 2024 and claims benefit to German Patent Application No. DE 10 2023 103 874.5, filed on Feb. 16, 2023. The International Application was published in German on Aug. 22, 2024 as WO 2024/170373 A1 under PCT Article 21(2).

### FIELD

The invention relates to a sealing arrangement and to the use thereof, where the sealing arrangement comprises a busbar with at least one electrical conductor which is sealed with respect to a support part by a sealing body.

### BACKGROUND

Oil-cooled electric motors are used in a growing number of electric vehicles. These oil-cooled electric motors present increased requirements in terms of their sealing, in particular with respect to the power electronics of further electrical parts, for example with respect to the power electronics of an inverter.

Moreover, use is made in electric vehicles of busbars which comprise electrical conductors made from pieces of copper or aluminum sheet metal which are stamped out and then bent into the desired dimension. For manufacturing reasons, these pieces of copper or aluminum sheet metal have a rectangular conductor cross section which is unsatisfactory for standard sealing because the corners of the stamped-out pieces of sheet metal do not allow robust compression of the sealing material of standard seals.

For this reason, it is also part of the prior art that the rectangular conductors are encapsulated mediatightly by a thermoplastic or thermoset. If necessary, the conductors are additionally bonded by an adhesive. A durable good sealing result is, however, consequently generally not obtained. The sealing result is only satisfactory initially and often displays leaks after being used for just a short period of time, in particular when the sealing points are exposed to temperature changes. The reason for this are different coefficients of thermal expansion of the electrical conductors and the sealing materials which surround the conductors. These different coefficients of thermal expansion of the two materials result in increased mechanical stresses at the boundary layers and thus in the above-described leaks.

It is moreover a disadvantage that the electrical conductors and the seals surrounding them cannot be detached from one another non-destructively. In the case of repair, the unit consisting of the electrical conductors and the seals has to be replaced as a whole, which is unsatisfactory in terms of good environmental protection, in terms of responsible handling of resources, and economically.

### SUMMARY

In an embodiment, the present disclosure provides a sealing arrangement that includes a busbar with at least one electrical conductor, and a two-component part. The two-component part includes a supporting part made of a semi-rigid material, and a sealing body made of a rubber-elastic sealing material, which is integrally bonded to the supporting part. The sealing body sealingly surrounds the electrical conductor without adhering to it.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a detail of an exemplary embodiment of a sealing arrangement in a perspective view; and

FIG. 2 shows a section through the sealing arrangement from FIG. 1.

### DETAILED DESCRIPTION

Embodiments of the present disclosure provide a sealing arrangement which provides solutions to the abovementioned disadvantages. The sealing arrangement of the present disclosure has consistently good use properties over a long period of use. Embodiments of the present disclosure enable electrical conductors and seals, when required, to be replaced separately from one another, and the electrical conductors and seals can be sorted and recycled. Use of the sealing arrangement of the present disclosure is also described herein.

Embodiments of the present disclosure provide a sealing arrangement which comprises a busbar with at least one electrical conductor and a two-component part which comprises a support part made from a tough but flexible material and a sealing body made from a rubber-elastic sealing material which is connected to the support part in a materially bonded fashion, wherein the sealing body sealingly surrounds the electrical conductor without adhering to it and with elastic pretension.

The sealing body of the two-component part can be made from a conventional rubber-elastic sealing material. Rubber-elastic sealing materials are available inexpensively in many specifications such that the sealing arrangement as a whole can be produced simply and inexpensively. The sealing body sealingly surrounds the electrical conductor without adhering to it and with elastic pretension. If required, sealing bodies and electrical conductors can therefore be replaced separately from one another. In particular, the ability to reuse the electrical conductor for almost as long as desired, said electrical conductor being made from an expensive material and experiencing virtually no wear during its period of use, is particularly advantageous.

According to an exemplary embodiment of the present disclosure, the support body is made from a tough but flexible plastic which is preferably electrically insulating. It is advantageous here that the two-component part can be produced simply and inexpensively and has only a low weight. The electrically insulating properties of the support part have the advantage that it does not need electrical insulation, which needs to be produced and fitted separately, with respect to a housing to which the two-component part is usually fixed.

The support body can, viewed in cross section, have an essentially L-shaped design, with an axial flange and a radial flange, wherein the axial flange extends parallel to the electrical conductor and surrounds the latter with a radial spacing, wherein at least one inner sealing lip of the sealing body is arranged in the gap formed by the spacing, said inner sealing lip sealingly surrounding the outer periphery of the electrical conductor without adhering to it and with elastic pretension. More preferably, two inner sealing lips arranged in a functional serial connection can be employed in order to further increase the reliability of the seal.

At least one outer sealing lip can be arranged on that side of the axial flange which faces away radially from the inner sealing lip. This outer sealing lip effects a seal with a housing to which the two-component part is fixed.

According to a first embodiment of the present disclosure, the inner sealing lip and the outer sealing lip are designed so that they merge integrally into each other and are made from the same material. It is advantageous here that the production of the two-component part is consequently particularly simple and inexpensive.

The inner sealing lip and the outer sealing lip are preferably made from an electrically insulating sealing material. In particular when the support part is also made from an electrically insulating material, the electrical conductors of the busbar and a housing to which the two-component part is fixed are effectively electrically insulated from one another.

According to a second embodiment of the present disclosure, the inner sealing lip and the outer sealing lip are each produced separately from each other and are associated with each other but are not in contact. It is advantageous here that the inner sealing lip and the outer sealing lip can each have distinct functions. The material properties of the sealing lips can be easily adapted to their respective function.

At least the inner sealing lip can be made from an electrically insulating sealing material. If the electrical conductor is sealed by the inner sealing lip and contact with the support part is prevented by the inner sealing lip, it is not absolutely necessary that the outer sealing lip also has to be made from an electrically insulating sealing material. Sealing materials can then also be used which do not have a particularly high electrical resistance but do enable a particularly durable and reliable seal, for example because they are particularly resistant to oil.

Additional sealing of the two-component part with respect to a housing to which it is fixed can be achieved by the radial flange having at least one axial sealing lip which extends axially in the direction of the outer sealing lip and substantially along the outer periphery of the support part. In such a case, the sealing of the two-component part is ensured by the interaction of the axial sealing lip and the outer sealing lip. The axial sealing lip and the outer sealing lip seal an opening in a housing in which the two-component part is arranged with respect to the surroundings.

According to an exemplary embodiment of the present disclosure, it can be provided that the electrical conductor has a round or oval cross section. It is advantageous here that, in contrast to an electrical conductor made from stamped-out sheet metal, it has no corners or process-related stamping burrs and robust compression of the sealing material is consequently possible. The round or oval cross section of the electrical conductor does not damage the inner sealing lip even in the case of relatively high elastic pretension.

The support part can have at least one fastening bore in which a force-limitation element is arranged. The support part can be screwed, for example, onto a housing. For this purpose, a screw first penetrates the fastening bore and is screwed into the housing. In order to prevent damage to the support part when it is screwed onto the housing by too high a tightening torque of the screw, the force-limitation elements which can be formed, for example, by force-limitation rings are provided. Undesirably high force which could result in the destruction of the support part if there were no force-limitation elements is consequently prevented.

The sealing arrangement can moreover comprise a liquid-cooled electrical part with a housing, wherein the housing has an installation opening in which the two-component part is arranged sealingly. The electrical part can be formed by an electric motor.

As already described herein, it is necessary in particular in the case of oil-cooled electric motors in electric vehicles to reliably seal sensitive power electronics, for example the power electronics of an inverter.

Embodiments of the present disclosure include the use of a sealing arrangement, as described above, for sealing a busbar of a liquid-cooled electrical part.

The above-described sealing arrangement can be produced simply and inexpensively. In the case of a possible repair, by virtue of the non-adherent association of the electrical conductor and the inner seal, the electrical conductor can always be reused. To do this, the electrical conductor is withdrawn from the inner seal, the existing support part with the existing sealing body, i.e. the two-component part, is replaced by a corresponding new pre-assembled unit and the electrical conductor is reassembled in the sealing body. The sealing arrangement moreover has a structure with a small number of parts. Assembly can be performed reliably because there is no need to assemble separately produced sealing rings.

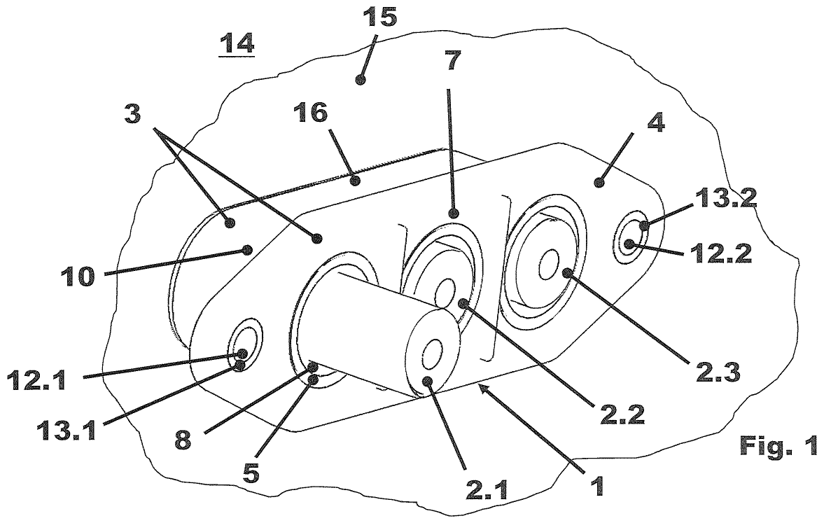

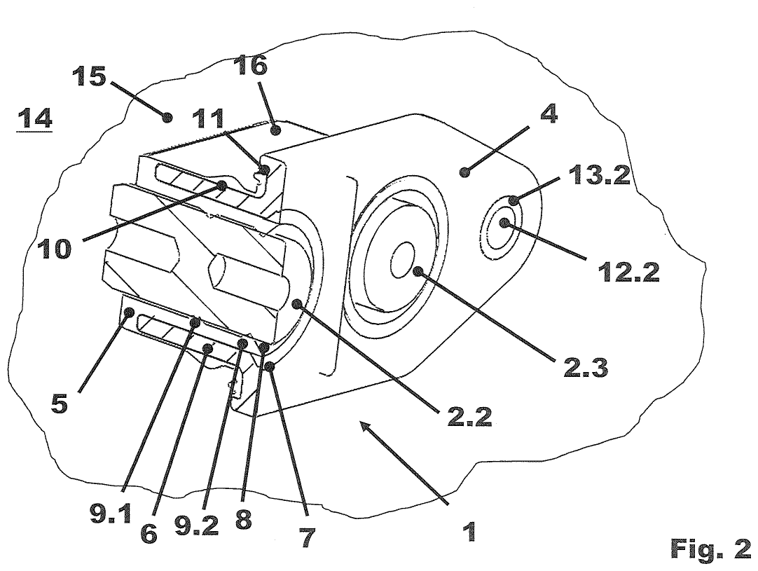

An exemplary embodiment of a sealing arrangement according to the present disclosure is shown in FIGS. 1 and 2.

In this exemplary embodiment, the busbar 1 comprises three electrical conductors 2.1, 2.2, 2.3 which each have a round cross section. The electrical conductors 2.1, 2.2, 2.3 are surrounded by the two-component part 3 which comprises the support part 4 and the sealing body 5. In this exemplary embodiment, the support part 4 is made from a tough but flexible and electrically insulating plastic, and the sealing body 5 from a rubber-elastic sealing material. The support part 4 and the sealing body 5 form a pre-assembled unit and are connected to each other in a materially bonded fashion.

The schematically indicated liquid-cooled electrical part 14 is formed by an oil-cooled electric motor for an electric vehicle and comprises the housing 15 which has an installation opening 16 for the two-component part 3. The two-component part 3 is arranged sealingly in the installation opening 16 of the housing 15. The two-component part 3 is screwed to the housing 15. Arranged in the support part 4 are the two fastening bores 12.1, 12.2 in which in each case an annular force-limitation element 13.1, 13.2 is arranged which is, for example, made from a metal material. The relatively more sensitive material of the support part 4 is consequently protected from excessively high tightening torques which could destroy the support part 4 whilst it is being assembled to the housing 15.

The sealing arrangement from FIG. 1 is shown in section in FIG. 2. It can be seen here that the support body 4, viewed in cross section, has an essentially L-shaped design and has an axial flange 6 and a radial flange 7. The axial flange 6 extends parallel to the electrical conductors 2.1, 2.2, 2.3 and the radial flange 7 perpendicularly thereto. The axial flange 6 is substantially surrounded completely by the sealing material of the sealing body 5, on the inside by the inner sealing lips 9.1, 9.2 and on the outside by the outer sealing lip 10.

In the exemplary embodiment shown in FIG. 2, the inner sealing lips 9.1, 9.2 and the outer sealing lip 10 merge integrally into one another and are made from the same electrically insulating sealing material. Such a design with integral merging of parts made from the same material is suitable for most use cases and can be produced simply and inexpensively.

The axial sealing lip 11, which is likewise designed so that it merges into the outer sealing lip 10 and the inner sealing lips 9.1, 9.2 and is made from the same material, is arranged on the radial flange 7 of the support part 4 and is bulged axially in the direction of the outer sealing lip 10 in the shape of a bead. The axial sealing lip 11 seals the end side of the housing 15, while the outer sealing lip 10 seals the peripheral border of the installation opening 16.

The sealing body 5 in each case sealingly surrounds the electrical conductors 2.1, 2.2, 2.3 without adhering to them and with pretension. When necessary, the electrical conductors 2.1, 2.2, 2.3 can therefore be detached from the sealing body 5 simply and non-destructively.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A sealing arrangement comprising:
a busbar with at least one electrical conductor; and
a two-component part comprising:
a support part made from a tough but flexible material; and
a sealing body made from a rubber-elastic sealing material which is connected to the support part in a materially bonded fashion, wherein the sealing body sealingly surrounds the at least one electrical conductor without adhering to it and with elastic pretension.

2. The sealing arrangement as claimed in claim 1, wherein the support part is made from an electrically insulating plastic.

3. The sealing arrangement as claimed in claim 1, wherein the support part, viewed in cross section, has an L-shaped design, with an axial flange and a radial flange, wherein the axial flange extends parallel to the at least one electrical conductor and surrounds the latter with a radial spacing, wherein at least one inner sealing lip of the sealing body is arranged in a gap formed by the spacing, the at least one inner sealing lip sealingly surrounding an outer periphery of the at least one electrical conductor without adhering to it and with elastic pretension.

4. The sealing arrangement as claimed in claim 3, wherein at least one outer sealing lip is arranged on a side of the axial flange which faces away radially from the at least one inner sealing lip.

5. The sealing arrangement as claimed in claim 4, wherein the at least one inner sealing lip and the at least one outer sealing lip are designed so that they merge integrally into each other and are made from a same material.

6. The sealing arrangement as claimed in claim 4, wherein the at least one inner sealing lip and the at least one outer sealing lip are made from an electrically insulating sealing material.

7. The sealing arrangement as claimed in claim 4, wherein the at least one inner sealing lip and the at least one outer sealing lip are each produced separately from each other and are associated with each other but are not in contact with each other.

8. The sealing arrangement as claimed in claim 7, wherein at least the at least one inner sealing lip is made from an electrically insulating sealing material.

9. The sealing arrangement as claimed in claim 4, wherein the radial flange has at least one axial sealing lip which extends axially in a direction of the at least one outer sealing lip and substantially along an outer periphery of the support part.

10. The sealing arrangement as claimed in claim 1, wherein the at least one electrical conductor has a round or oval cross section.

11. The sealing arrangement as claimed in claim 1, wherein the support part has at least one fastening bore in which a force-limitation element is arranged.

12. The sealing arrangement as claimed in claim 1, further comprising a liquid-cooled electrical part with a housing, wherein the housing has an installation opening in which the two-component part is arranged sealingly.

13. The sealing arrangement as claimed in claim 12, wherein the liquid-cooled electrical part is formed by an electric motor.

14. A method for sealing a busbar of a liquid-cooled electric part via a sealing arrangement as claimed in claim 1.
